(19) United States
(12) Patent Application Publication
(10) Pub. No.: US 2019/0004006 A1
(43) Pub. Date: Jan. 3, 2019

(54) POTENTIOSTAT CIRCUIT

(71) Applicant: Arch Chemicals, Inc., Allendale, NJ (US)

(72) Inventor: Mark E. Johnson, Canton, GA (US)

(21) Appl. No.: 16/026,240

(22) Filed: Jul. 3, 2018

Related U.S. Application Data
(60) Provisional application No. 62/528,305, filed on Jul. 3, 2017.

(51) Int. Cl. G01N 27/404; G01N 27/49; G05F 1/56

(52) U.S. Cl. CPC G01N 27/4045; G05F 1/561; G01N 27/49

(57) ABSTRACT

A potentiostat circuit is described for the detection and analysis of analytes within an uncompartmented or galvanically connected pool of liquid and which permits sequential and simultaneous measurements to be performed in multiple electrochemical cells within the uncompartmented or galvanically connected pool of liquid by one or more potentiostats. Accordingly, the potentiostat circuit includes a grounded counter electrode that is configured to prevent against electrical interference when measuring analytes in a fluid sample. The grounded counter electrode can completely surround a working electrode and a reference electrode and can be held at a common potential voltage during operation. The grounded counter electrode can have a U-shape for surrounding on three sides the working electrode and the reference electrode.

### RELATED APPLICATIONS

The present application is based on and claims priority to U.S. Provisional Application Ser. No. 62/528,305, having a filing date of Jul. 3, 2017, which is incorporated herein by reference in its entirety.

### BACKGROUND

A potentiostat is a control and measurement apparatus commonly used in the electrochemical field. A potentiostat includes an electronic circuit which can be used to control the operations of the potentiostat, including controlling potential across an electrochemical cell. A potentiostat can be used with or included with electrochemical devices for sensing or measuring the concentration of isolated atoms or molecules within a fluid, such as a gas or liquid. A potentiostat can be used with electrochemical devices, such as electrochemical sensors, that are used in numerous and different applications. For instance, a potentiostat can be used with thin film electrochemical sensors to test analyte levels in patients in various different medical applications. For instance, a potentiostat and such electrochemical devices can be used to measure an analyte in the blood of a patient suffering from a metabolic disease, a blood disease, or any other disease that causes an imbalance in the blood. For example, thin film electrochemical devices have been used in the past for indicating blood glucose levels in patients, such as patients suffering from diabetes.

Electrochemical devices have also been used to measure analytes in aqueous systems, such as in pool and spa water. Pool and spa water, for instance, is typically monitored for free available chlorine, total available chlorine, total hardness, total alkalinity, cyanuric acid, copper, and other analytes. The above analytes are monitored and controlled in order to maintain water quality, especially water used for recreational and industrial purposes.

In the past, a conventional potentiostat has included an electrochemical cell having two or three electrodes, such as a reference electrode, a working electrode, and a counter electrode. Conventional potentiostat circuits can control the voltage difference between two electrodes which can be either a positive voltage difference, a negative voltage difference, or an alternating current voltage difference either with or without positive or negative DC voltage bias. The voltage is typically controlled by injecting current into the electrochemical cell through a counter electrode. In many applications, electrochemical device measures the current flow between the working electrode and the counter electrode. For example, conventional potentiostats are configured to control the potential of the working electrode at a constant level with respect to the reference electrode by adjusting the current at the counter electrode. As such, a particular, and in some instances varying, amount of current is injected into the electrochemical cell at the counter electrode such that when the voltage measured across the working electrode and reference electrode remains constant or near constant.

In the past, problems have been experienced, however, in preventing interference during the taking of measurements which can result in errors. These problems can become exacerbated when the electrochemical device contains multiple electrochemical cells and more than one potentiostat is used in an attempt to simultaneously take different measurements of different analytes contained in a fluid. For instance, when more than one conventional potentiostat is used simultaneously within an uncompartmented or galvanically connected pool of liquid, the counter electrode of each electrochemical device may be maintained at different voltages. As a result, leakage current from one electrochemical cell can affect the counter electrode contained in other electrochemical cells within the uncompartmented or galvanically connected pool of liquid. This leakage current can interfere with the operation of one or more of the potentiostats that are being used to take measurements of the different analyst contained in the uncompartmented or galvanically connected pool of liquid. For instance, the leakage current can cause a current flow imbalance which impedes the ability of the one or more potentiostat circuits to control the potential of the working electrode at a constant level with respect to the reference electrode by adjusting the current at the counter electrode.

In this regard, a need currently exists for a potentiostat circuit design that can reduce interference, such as galvanic electrical interference, between multiple potentiostats and electrochemical devices that can be used to simultaneously take different measurements of different analytes contained within an uncompartmented or galvanically connected pool of liquid.

### SUMMARY

The present disclosure is generally directed to an electrochemical sensor having an electrode design that minimizes or eliminates electrical interference during the taking of measurements. The electrochemical sensor of the present disclosure is particularly well suited for measuring one or more analytes in a fluid, such as a liquid or a gas.

One example aspect of the present disclosure is directed to a potentiostat circuit. The potentiostat circuit includes and electrochemical cell, a reference electrode in electrical communication with a first high impedance component, a working electrode in electrical communication with a second high impedance component and a counter electrode in electrical communication with a circuit ground. The potentiostat circuit can further include a first operational amplifier which is configured to receive a reference electrode voltage at a first input terminal and general a first output voltage based on the reference electrode voltage at a first output terminal. The potentiostat circuit can further include a second operational amplifier which is configured to receive a working electrode voltage at a first input terminal and generate a second output voltage based on the working electrode voltage at a second output terminal.

Another example aspect of the present disclosure is directed to an apparatus for measuring analytes in a fluid. The apparatus includes a reservoir for holding a fluid and an electrochemical sensor including a support having a first side and a second and opposite side. The apparatus also includes an electrochemical cell disposed on the first side of the support, the at least one electrochemical cell including a reference electrode having an end that is contiguous with a first side and a second side, a working electrode spaced from the reference electrode that also has an end that is contiguous with a first side and a second side, and a counter electrode, the counter electrode having a shape that defines an electrode receiving area, the electrode receiving area surrounding the first side, the second side, and the end of the reference electrode and the working electrode. The apparatus also includes a first high impedance component in electrical communication with the reference electrode, a second high impedance component in electrical communication with the working electrode and a circuit ground in electrical communication with the counter electrode. The apparatus also includes an analyzing device that electrically connects to each of the reference electrode, working electrode and counter electrode, the analyzing device being configured to simultaneously measure different analytes loaded into the fluid reservoir.

The spacing between the different electrodes can vary depending upon the particular application. In one embodiment, for instance, the working electrode and the reference electrode are spaced closer together in relation to the spacing between the working electrode and the reference electrode to the counter electrode. As used herein, the spacing is measured from a side edge of an electrode to a side edge of an adjacent electrode. In one embodiment, the distance between the counter electrode and the working electrode and/or reference electrode is greater than the distance between the working electrode and the reference electrode. For example, the distance between the counter electrode and the other electrodes can be up to 5 times greater than the distance between the working electrode and the reference electrode. For instance, the distance between the counter electrode and one of the other electrodes can be from about 1.2 to about 3 times greater, such as from about 1.6 to about 2.4 times greater, such as from about 1.9 to about 2.1 times greater than the distance between the working electrode and the reference electrode.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a plan view of an electrochemical sensor that can be used with the potentiostat circuit of the present disclosure;

FIG. 2 is a plan view of another embodiment of an electrochemical sensor that can be used with the potentiostat circuit of the present disclosure;

FIG. 3 is a plan view of still another embodiment of an electrochemical sensor that can be used with the potentiostat circuit of the present disclosure, electrochemical sensor including a plurality of electrochemical cells, one terminal electrochemical cell, and one isolated electrochemical cell;

FIG. 4 is another view of an electrochemical sensor shown in FIG. 3 illustrating one embodiment of an electrode construction;

FIG. 5 depicts a diagram of an example of a conventional potentiostat circuit utilizing isolated counter electrodes;

FIG. 6. depicts a diagram of a non-conventional potentiostat circuit utilizing a grounded common counter electrode according to example embodiments of the present disclosure; and

FIG. 7 depicts an electrical schematic of a non-conventional potentiostat circuit according to example embodiments of the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

The present disclosure is generally directed to a potentiostat circuit for the detection and analysis of analytes within an uncompartmented or galvanically connected pool of liquid. The potentiostat circuit of the present disclosure permits multiple potentiostats to simultaneously measure chemical concentrations of different analytes within the same, uncompartmented pool of liquid. In one embodiment, the potentiostat circuit includes a common counter electrode, which is always held at a common voltage, which can include a common low impedance voltage or a common voltage such as at circuit ground (+0V DC), and that is configured to prevent against electrical interference when measuring analytes in the uncompartmented fluid sample. For example, in one embodiment, the grounded common counter electrode can completely surround a working electrode and a reference electrode and the common counter electrode can be held at a common potential voltage during operation. In some embodiments, the counter electrode can have a U-shape for surrounding on three sides the working electrode and the reference electrode. In some embodiments, the grounded counter electrode can be connected to ground or to source for common potential voltage at each electrochemical cell. In other embodiments, the common counter electrode can be grounded at or connected to source for common potential voltage at a single point of electrical contact.

The potentiostat circuit of the present disclosure can be used with an electrochemical sensor for sensing an analyte, such as an atom, compound, molecule, oligomer, polymer, etc., in a fluid, such as a liquid or gas. An example of such an electrochemical sensor is a single electrochemical cell for measuring the concentration of a single analyte. However, the electrochemical sensor can include a plurality of electrochemical cells which permit simultaneous sensing of concentrations of the same or different analytes within a fluid. For example, the electrochemical sensor can include from about 2 to about 20 electrochemical cells, such as from about 3 to about 12 electrochemical cells, wherein each cell is configured to measure a different analyte in the same sample of fluid that may be contained in an uncompartmented reservoir. Of particular advantage as will be described in greater detail below, at least a subset of the electrochemical cells can perform simultaneous measurements without the need for galvanic isolation.

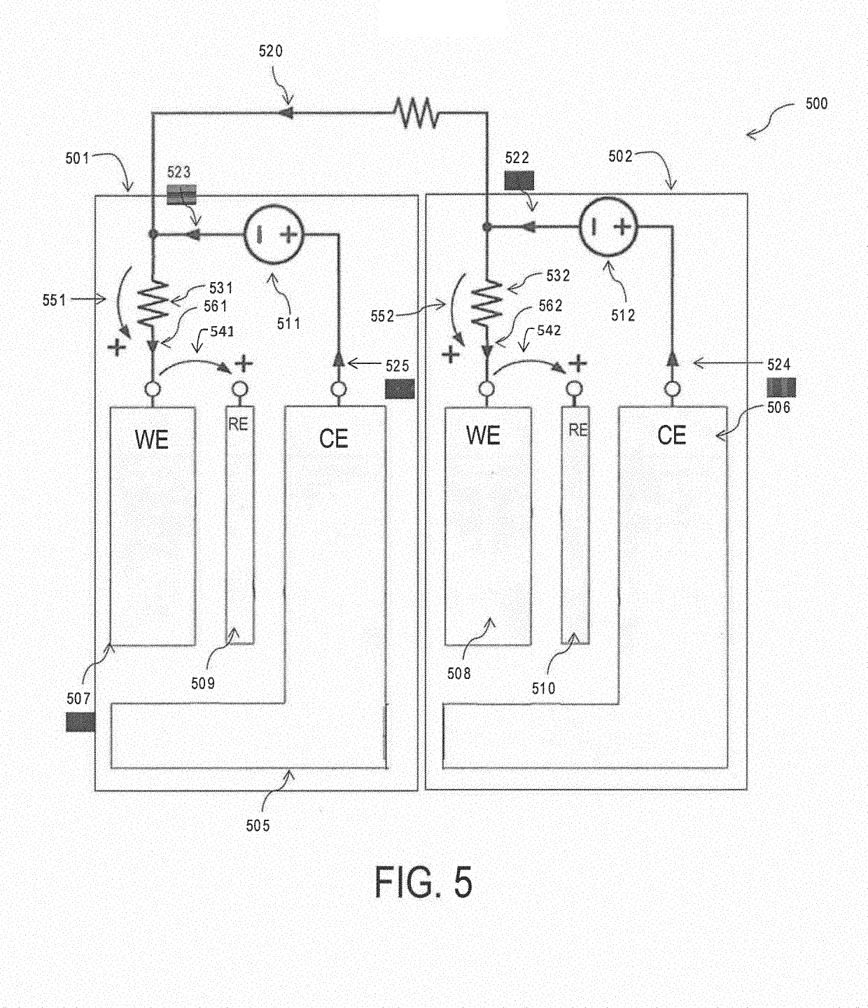

In the past, problems were experienced in attempting to take simultaneous measurements of different analytes in a liquid substance using the same electrochemical device or two or more conventional potentiostats and potentiostat circuits. Liquid substances, for instance, have non-zero volumetric electrical resistances. When attempting to take multiple measurements simultaneously from the same liquid sample with multiple conventional potentiostats, the multiple conventional potentiostats present in the same electrochemical cell may operate at different voltages and currents, the three dimensional electrical resistance of a liquid substance can cause undesirable mixing of electrical currents between adjacently located conventional potentiostats within the same electrochemical cells thereby rendering invalid assay measurement results from each conventional potentiostat operating within the same physical cell. A diagram of such a conventional potentiostat circuit utilizing isolated counter electrodes is depicted in FIG. 5, which is more fully described herein.

The potentiostat circuit of the present disclosure, however, prevents electrical cross current contamination by rearranging the electrical control and operation of the electrodes and the electrochemical cells such that current flow between adjacent cells does not cause measurement errors. More particularly, in accordance with the present disclosure, a plurality of potentiostat circuits and electrochemical cells share a grounded common counter electrode. In one embodiment, the grounded common counter electrode can surround the other working electrodes in each individual electrochemical cell. In accordance with the present disclosure, the common grounded counter electrode can be held at a common potential voltage, such as +0 VDC, thereby minimizing electrical interference between the different adjacent cells. Thus, potentiostat circuits made according to the present disclosure operate by controlling a voltage difference between a working electrode and a reference electrode while maintaining the counter electrode at a common potential voltage.

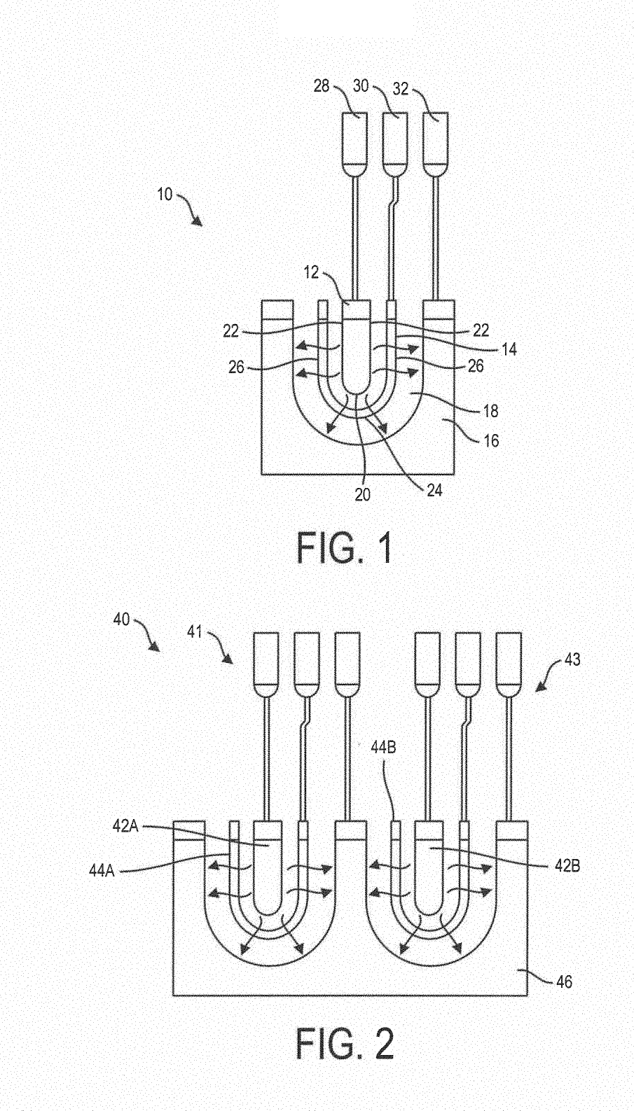

Electrochemical sensors that can be used with the potentiostat circuit of the present disclosure can include a single electrochemical cell or can comprise a plurality of electrochemical cells. Referring to FIG. 1, an electrochemical device 10 is illustrated that includes only a single electrochemical cell. As shown, the electrochemical device 10 includes a working electrode 12 spaced from a reference electrode 14. In accordance with the present disclosure, the electrochemical device 10 further includes a counter electrode 16. As shown in FIG. 1, the counter electrode 16 has a U-shape that forms an electrode receiving area 18. The working electrode 12 and the reference electrode 14 are inserted into the electrode receiving area 18.

For instance, the working electrode 12 can include an end 20 contiguous with two opposing sides 22 and 22′. The reference electrode 14 includes an end 24 and opposing sides 26 and 26′. As shown, the walls of the counter electrode surround the end and the sides of both the working electrode 12 and the reference electrode 14. In this manner, the counter electrode not only assists in measuring for analytes but also serves to minimize any electronic interference.

In the example electrochemical sensor illustrated in FIG. 1, the reference electrode 14 has a U-shape for surrounding the working electrode 12. In other embodiments, however, the working electrode 12 and the reference electrode 14 can be positioned in a side by side relationship.

As shown in FIG. 1, in one embodiment, the working electrode 12 and the reference electrode 13 can be spaced closer together than the distance between the reference electrode 14 and the counter electrode 16. For example, the distance between the counter electrode 16 and the reference electrode 14 can be from about 1 to about 5 times, such as from about 1.2 to about 3 times, such as from about 1.6 to about 2.4 times, such as from about 1.9 to about 2.1 times greater than the distance between the reference electrode 14 and the working electrode 12.

Each of the electrodes can also include an electrical contact for connecting the electrochemical device 10 to a controller for controlling voltages and taking measurements. For example, the working electrode 12 is electrically connected to the electrical contact 28. The reference electrode 14 is electrically connected to the electrical contact 30 while the counter electrode 16 is electrically connected to the electrical contact 32.

The electrodes 12, 14 and 16 can generally be made from any suitable conductive material. For instance, the electrodes can be made from gold, silver, platinum, conductive carbon, a conductive polymer, compounds thereof, and mixtures thereof. Similarly, the electrical connectors 28, 30 and 32 can also be made from any suitable conductive material, such as any of the materials described above. The electrical contacts 28, 30 and 32 can be made from the same material or from a different material than the corresponding electrodes 12, 14 and 16.

In order to sense the presence of an analyte, the working electrode 12 can be associated with a reagent composition. The reagent composition can be formulated to create a current as shown by the arrows in FIG. 1 when a fluid containing the analyte is contacted with the electrodes. For example, in one embodiment, the reagent composition can comprise a coating applied to the working electrode 12. The reagent composition can coat the entire surface area of the working electrode 12 or can coat only a portion of the surface area of the working electrode.

The reagent composition used in the electrochemical device can generally comprise any suitable reagent composition for detecting any analyte that may be desired. For example, in one embodiment, the electrochemical device can be used to measure the concentration of an analyte in a biological fluid, such as blood or urine. In one particular embodiment, the reagent composition can be used to measure the concentration of glucose in blood. For example, in one embodiment, the reagent composition may comprise glucose oxidase enzyme for detecting the concentration of glucose in a fluid. In an alternative embodiment, glucose can be sensed using a non-enzymatic composition. For example, in one embodiment, the working electrode 12 may be covered by a membrane that is sized to keep larger molecules, such as those having a molecular weight greater than 100,000, from passing through. The membrane, for instance, can filter out proteins and lipids while allowing glucose to pass. The membrane, for instance, can be made from cellulose esters, nylon, polyvinyl fluoride, polytetrafluoroethylene, cellulose nitrate, acetate, and mixtures thereof. The reagent composition that detects the presence of glucose, on the other hand, may comprise a coating of tin oxide or tin dioxide that comprises the working electrode 12. In this embodiment, glucose passing through the membrane undergoes an oxidation reaction under applied positive voltage which then allows for a concentration measurement to be taken.

In other embodiments, a reagent composition can be used for detecting an analyte contained in pool water, which includes spa water. Analytes that may be measured in pool water include for instance, free chlorine, total chlorine, calcium hardness, copper, total alkalinity, cyanuric acid, and the like.

In order to operate the electrochemical device 10 as shown in FIG. 1, the counter electrode 16 can be held at a common potential voltage and may comprise, for instance, a circuit ground. Having the counter electrode be at a common potential voltage prevents electrical currents from penetrating the counter electrode and creating interference when taking a measurement. In the electrochemical device as shown in FIG. 1, for instance, the voltage can be varied between the working electrode 12 and the reference electrode 14. For example, a controller can alter and maintain the required specific voltage difference between the working electrode and the reference electrode. By way of example, any/all of the “control devices” or “controllers” discussed in this disclosure can include a memory and one or more processing devices such as microprocessors, CPUs or the like, such as general or special purpose microprocessors operable to execute programming instructions or micro-control code associated with operation of a potentiostat circuit or electrochemical device 10. The memory can represent random access memory such as DRAM, or read only memory such as ROM or FLASH. In one embodiment, the processor executes programming instructions stored in memory. The memory can be a separate component from the processor or can be included onboard within the processor. As used herein, the term “processor” refers not only to integrated circuits referred to in the art as being included in a computer, but also refers to a controller, microcontroller, a microcomputer, a programmable logic controller (PLC), an application specific integrated circuit (ASIC), and other programmable circuits. Additionally, the memory may generally include memory element(s) including, but not limited to, a computer readable medium (e.g., random access memory (RAM)), computer readable non-volatile medium (e.g., flash memory) and/or other suitable memory elements.

In one embodiment, for instance, the working electrode 12 is an electrode where the potential is controlled and where the current is measured. The working electrode serves as a surface on which an electrochemical reaction takes place. The reference electrode provides a potential measurement necessary to control the potential of the working electrode. A controller maintains the potential difference between the reference electrode and the working electrode to be equal to a user supplied input control potential required for analysis of any specific reagent composition. The counter electrode, on the other hand, is a conductor that completes the cell circuit. Current flowing into the sample fluid via the working electrode leaves the fluid via the counter electrode.

Referring now to FIG. 2, another electrochemical device 40 which can be used with the potentiostat circuit of the present disclosure is shown. The electrochemical device 40 is similar to the electrochemical device 10 as shown in FIG. 1. The electrochemical device 40, however, includes a plurality of electrochemical cells. In the embodiment illustrated, for instance, the electrochemical device 40 includes a first electrochemical cell 41 and a second electrochemical cell 43.

The spacing between the working electrode 42 and the reference electrode 44 and the spacing between the counter electrode 46 and the reference electrodes 44A and 44B can be the same as described above with respect to FIG. 1. For instance, the counter electrode 46 can be spaced a farther distance from the reference electrodes 44A and 44B in relation to the space between the working electrode 42 and the reference electrode 44.

The first electrochemical cell 41 includes a working electrode 42A spaced from a reference electrode 44A. The second electrochemical cell 43, on the other hand, includes a working electrode 42B spaced from a reference electrode 44B. In accordance with the present disclosure, the electrochemical device 10 includes a common counter electrode 46. As shown, the counter electrode 46 is a continuous structure that surrounds the electrodes of the first electrochemical cell 41 and surrounds the electrodes of the second electrochemical cell 43.

As shown in FIG. 2, the first electrochemical cell 41 and the second electrochemical cell 43 share the common counter electrode 46 which, in one embodiment, is held at a common potential voltage, such as at circuit ground. In this manner, current from the working electrodes 42A and 42B are prevented from interfering with the adjacent electrochemical cell. The electrical current generated by each cell can then be easily measured across a resistor placed in series with a corresponding working electrode when a desired voltage difference is maintained between the working electrode and the reference electrode. Consequently, multiple and simultaneous measurements of a fluid can occur. More particularly, the electrochemical device 40 as shown in FIG. 2 is capable of simultaneously sensing the concentrations of the same or different analytes within a fluid, such as a liquid, by simply submerging the electrochemical device 40 within a sample of the fluid.

In order to measure an analyte, the working electrodes 42A and 42B can be placed in association with a reagent composition. The reagent composition can comprise, for instance, a coating on the electrode, a material that is incorporated into the electrode and/or a composition added to the test sample.

In one embodiment, the working electrodes 42A and 42B can be associated with the same reagent composition for taking two measurements of the same analyte in a fluid sample. For example, duel measurements may be taken in order to improve accuracy and detect any measurement errors. For example, in one embodiment, both working electrodes 42A and 42B can be associated with a reagent composition designed to detect glucose in a fluid such as a body fluid.

Alternatively, each working electrode 42A and 42B can be associated with a different reagent composition for simultaneously sensing the concentration of two different analytes in a fluid sample. For example, in one embodiment, the electrochemical device 10 may be used to sense and monitor two different analytes in pool or spa water. For example, in one embodiment, working electrode 42A can be associated with a reagent composition for detecting alkalinity while reference electrode 42B can be associated with a reagent composition for detecting chlorine concentration.

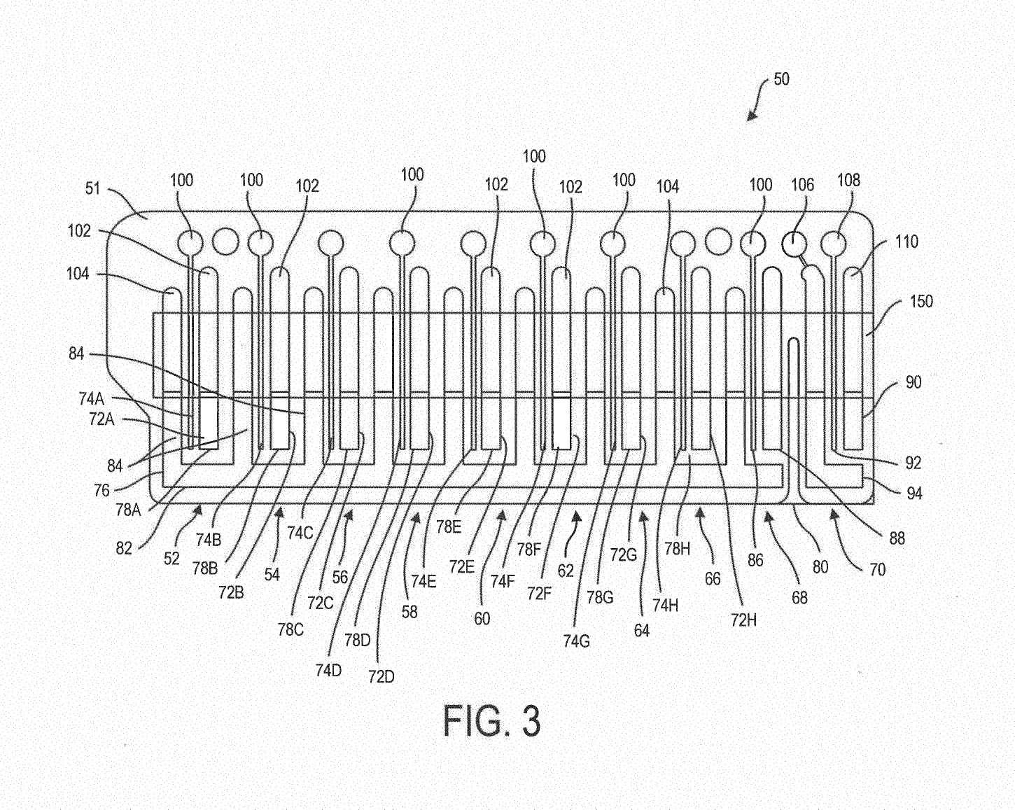

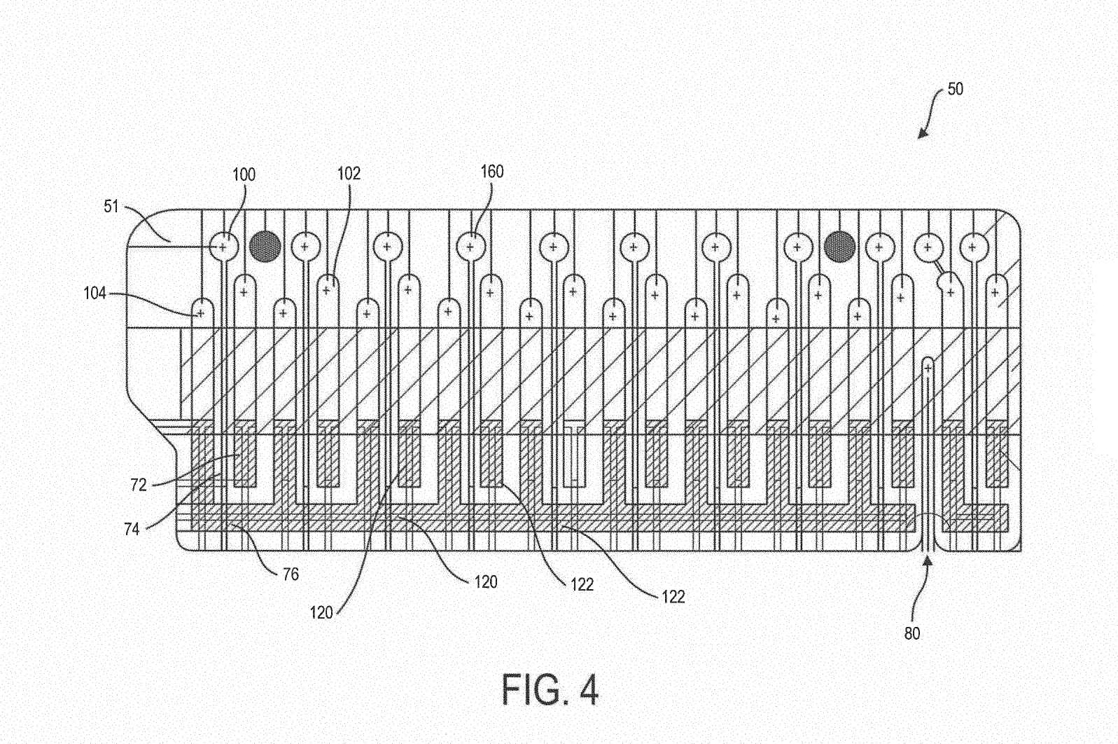

Referring now to FIGS. 3 and 4, another embodiment of an electrochemical device 50 that can be used with the potentiostat circuit of present disclosure is shown. The electrochemical device 50 includes a support 51, which may comprise a film, that has disposed on one side a plurality of electrochemical cells. For example, in the embodiment illustrated in FIGS. 3 and 4, the electrochemical device 50 includes ten electrochemical cells 52, 54, 56, 58, 60, 62, 64, 66, 68 and 70 for taking ten separate measurements simultaneously when the electrochemical device 50 is contacted with a fluid sample.

In general, the support 51 is formed from a material which is electrically non-conductive and inert to the testing environment and chemicals applied thereto. As described above, in one embodiment, the support 51 comprises a film, such as a flexible film. The film can be made from any suitable material, such as ceramic, paper, glass, or a polymer. When formed from a polymer, the film can be made from any suitable non-conductive material, such as polyester, polycarbonate, polyvinylchloride, or a polyolefin such as polyethylene or polypropylene.

In one embodiment, the electrochemical cells disposed on the support 51 are applied to the support through a printing process. For instance, the electrodes, electrical contacts, and insulating layers can all be made from compositions that can be printed on to the substrate. For example, the different materials can be applied to the support 51 using screen printing, lithography, vapor deposition, spray coating, vacuum deposition, inkjet printing, and combinations thereof.

Various different conductive compositions, such as conductive inks, are available that can be applied to the support 51. The conductive composition, for instance, can contain metal ions or a conductive metal compound. In addition, carbon base materials are available that are also highly conductive. Metals that can be contained in the composition include gold, silver, platinum, and/or conductive noble metals. For example, in one embodiment, silver chloride may be used to produce the electrodes or any other conductive parts of the electrochemical device 50.

As shown in FIG. 3, the electrochemical device 50 includes ten different electrochemical cells. Electrochemical cells 52, 54, 56, 58, 60, 62, 64 and 66 form a plurality of electrochemical cells that have a similar configuration. In addition, the electrochemical device 50 includes a terminal electrochemical cell 68 and an isolated electrochemical cell 70. Electrochemical cell 70, for instance, can be electrically isolated from the remainder of the electrochemical cells using any suitable insulating barrier. In the embodiment illustrated in FIGS. 3 and 4 for instance, the isolated electrochemical cell 70 is isolated from the remainder of the electrochemical cells by a slot 80 formed into the support 51.

Electrochemical cells 52, 54, 56, 58, 60, 62, 64 and 66 each include a working electrode 72A, 72B, 72C, 72D, 72E, 72F, 72G, and 72H, and a reference electrode 74A, 74B, 74C, 74D, 74E, 74F, 74G, and 74H. The working electrode 72 is spaced from the reference electrode 74. During operation of the electrochemical device, an analyzing device can be electrically connected to each of the electrodes and can apply a voltage difference between the working electrode 72 and the reference electrode 74. The voltage difference can be the same within each electrochemical cell or can be different. In one embodiment, for instance, an analyzer can be programmed to apply a different voltage difference between the working electrode and the reference electrode depending upon the analyte being measured. For example, in some embodiments, a controller can be programmed to apply a different voltage difference between the working electrode and the reference electrode depending upon the analyte being measured. For example, the voltage difference between the reference electrode and the working electrode can be less than about ^{+/-}0.1 volts, such as less than about ^{+/-}0.3 volts, such as less than about ^{+/-}0.5 volts, such as less than about ^{+/-}0.7 volts, such as less than about ^{+/-}1 volts, such as less than about ^{+/-}1.2 volts, such as less than about ^{+/-}1.5 volts, such as less than about ^{+/-}1.7 volts, such as less than about ^{+/-}2 volts, such as less than about ^{+/-}2.5 volts, such as less than about ^{+/-}3 volts. The difference is generally greater than ^{+/-}20 volts, such as greater than about ^{+/-}10 volts, such as greater than about ^{+/-}5 volts. The voltage difference, however, can vary and fall outside the above ranges depending upon the particular application and the desired result. For example, in another embodiment, the difference between the reference electrode and the working electrode can exist anywhere within a range of +2.0 volts to −2.0 volts depending on the electrochemical characteristics of the particular analyte and testing being performed. The voltage difference, however, can vary and fall outside the above ranges depending upon the particular application and the desired result.

In accordance with the present disclosure, electrochemical cells 52, 54, 56, 58, 60, 62, 64 and 66 include a common counter electrode 76. As shown in FIG. 3, the common counter electrode 76 can comprise a continuous structure and can include a common base electrode portion 82 connected to vertical arm portions 84. In this manner, the common counter electrode 76 has a U-shaped structure associated with each electrochemical cell and forms electrode receiving areas 78A, 78B, 78C, 78D, 78E, 78F, 78G, and 78H. The electrode receiving areas 78 surround on three sides the working electrodes 72 and the reference electrodes 74 contained in each of the electrochemical cells. By surrounding the working electrode and reference electrode of each of electrochemical cell and by being maintained at a common potential voltage during operation, the counter electrode 76 not only has utility and for providing analyte measurements but also prevents against electrical interference from the adjacent cells.

Similar to the other embodiments, in one embodiment, the distance between the counter electrode 76 and the working electrode 72 or the reference electrode 74 is greater than the distance between the working electrode 72 and the reference electrode 74. For example, in the embodiment illustrated in FIG. 3, the distance between the counter electrode 76 and the working electrode 72 can be from about 1 to about 5 times greater, such as from about 1.2 to about 3 times greater, such as from about 1.6 to about 2.4 times greater, such as from about 1.9 to about 2.1 times greater than the distance between the working electrode 72 and the reference electrode 74. Similarly, the distance between the counter electrode 76 and the reference electrode 74 can also be from about 1 to about 5 times greater, such as from about 1.2 to about 3 times greater, such as from about 1.6 to about 2.4 times greater, such as from about 1.9 to about 2.1 times greater than the distance between the working electrode 72 and the reference electrode 74.

As shown in FIG. 3, the electrochemical device 50 also includes the terminal electrochemical cell 68 positioned at an end of the plurality of electrochemical cells 52, 54, 56, 58, 60, 62, 64 and 66. The electrochemical cell 68 includes a reference electrode 86 and a working electrode 88. Although the terminal electrochemical cell 68 utilizes the common counter electrode 76, the common counter electrode 76 does not surround on three sides the reference electrode 86 and the working electrode 88. By being located on the end of the plurality of electrochemical cells and by being located adjacent to the slot 80, it is not necessary for the counter electrode to completely surround the reference electrode 86 and the working electrode 88 in order to prevent against electrical interference.

In addition to the terminal electrochemical cell 68, the electrochemical device 50 further includes an isolated electrochemical cell 70. The isolated electrochemical cell 70 includes a working electrode 90, a reference electrode 92, and a separate counter electrode 94. In some instance, it may be desirable to include an electrochemical cell with the electrochemical device 50 that is electrically isolated from the remainder of the electrochemical cells. For instance, the isolated electrochemical cell 70 may generate strong electrical currents that can interfere with the other electrochemical cells or may be highly sensitive to any electronic interference. By including the slot 80 or any other type of electrical insulating barrier, the electrochemical device 50 can include an isolated electrochemical cell 70 in order to further measure other analytes in the sample fluid.

In one embodiment, the electrochemical cell 50 is shown in FIGS. 3 and 4 can be used to simultaneously measure different analytes in a sample of pool or spa water. For example, the ten electrochemical cells can be used to measure Total Dissolved Solids (TDS), copper, borate, bromine, iron, total alkalinity, total chlorine, free chlorine, calcium hardness, hydrogen peroxide and cyanuric acid in a fluid sample simultaneously. In one embodiment, each of the electrochemical cells can be placed in association with a different reagent for measuring each of the different analytes. One of the electrochemical cells, however, may not need a reagent for measuring a particular analyte. For instance, total dissolved solids can be measured using a blank sensor with no reagent.

Chlorine levels in pool water, for instance, can be important for disinfecting or sanitizing the water by destroying microorganisms, such as bacteria, fungi, viruses, and algae. Pool water is typically measured for free chlorine and total chlorine. Free chlorine generally refers to the concentration of Cl₂, HOCl, or OCl⁻. Total chlorine, on the other hand, is the sum of free available chlorine and combined available chlorine. Combined available chlorine refers to chlorine species associated with inorganic chloramines and organic chloramines in water.

In order to maintain pH in a desired range, total alkalinity can be measured in pool water. Total alkalinity is a measure of the buffering capacity of the water to resist pH change. Total alkalinity can be measured by measuring the amount of carbonate and bicarbonate in the sample.

Total hardness or calcium hardness is the measure of water hardness. Calcium and magnesium ions are the primary sources of water hardness. High calcium hardness can result in cloudy water and scale formation while low calcium levels can lead to corrosion.

Cyanuric acid levels in pool water can be important in order to stabilize free available chlorine in the water. Cyanuric acid, for instance, can protect free available chlorine against UV light degradation.

In addition to the above, various other analytes can be measured in pool water including bromine, iron and copper. Bromine serves as a sanitizer. Iron and copper, on the other hand, can be monitored in order to prevent against increased levels than can result in staining and high sanitizer consumption.

When the electrochemical device 50 is shown in FIGS. 3 and 4 is used to measure analytes in pool water, most of the working electrodes 72 can be associated with a different reagent composition for measuring a different analyte in the pool water sample. In other embodiments, various different electrochemical cells can be used to measure the same analyte as a way to ensure accuracy. The reagent compositions, in one embodiment, can be applied to the working electrode as a coating or can be combined with the conductive composition that is used to form the electrode.

Reagent compositions that can be applied to the working electrodes in accordance with the present disclosure are as follows.

Free Chlorine Detection Reagent Composition

The free chlorine reagent composition for the free chorine electrochemical sensor according to the invention, measures the content of free chlorine in water by the amperometric analysis. The reagent composition for the free chlorine electrochemical sensor will generally contain a redox indicator reagent, a buffer and a polymeric material. Typically, water is used as the solvent for the composition and the components are added so that the resulting composition has the component present in an amount disclosed below. These components are generally mixed and applied to the second surface of the working electrode. The solvent is removed by drying the composition at an elevated temperature for a period of time.

Suitable redox indicator reagents include, for example p-phenylenediamine salts, N,N-diethyl-p-phenylenediamine sulfate salt (DPD), N,N-dimethyl-p-phenylenediamine sulfate salt, and N,N,N′N′-tetramethyl-p-phenylenediamine. The redox indicator reagent component is added to the reagent composition to form a solution which is about 0.01 M to about 0.20 M, and more typically in a 0.03 to about a 0.07 M.

Suitable buffers include phthalate buffers, phosphate buffers. Phosphate buffers include, for example disodium hydrogen phosphate, sodium di-hydrogen phosphate, and mixtures thereof. The buffer component is generally present in the reagent composition in the range of about 0.01 to about 0.03 M.

Sodium chloride is generally added to the buffer in a concentration of about 0.3 to about 0.6 M. Typically, it is added in an amount of about 0.4 to about 0.5 M.

In addition, the reagent composition will also have a polymeric component added to assist disposition of the redox indicator reagent to the surface of the electrode. In addition, the polymeric material in the reagent composition is used to retain reagent and buffer mixture on the electrode surface, and stabilizing the response of electrochemical detection. Possible polymers include, for example, polyethylene glycol, sodium alginate, polyvinyl alcohol, or other similar polyelectrolyte polymers. Generally, polyethylene glycol is used for the free chlorine sensor. Typically, the polymer is added in an amount of about 0.1 to about 2.0% by weight, based on the volume of the solution.

In the electrochemical sensor containing a free chlorine reagent composition applied to the working electrode, the amount of free chlorine is measured by generating a voltage, such as a desired voltage or user selected voltage, applied between the reference electrode and the working electrode, and the resulting current from the working electrode is measured, according to the reaction shown below:

HOCl+2e-↔Cl⁻+OH⁻

The sensor is polarized at a potential value (vs Ag/AgCl) for a time period. The current observed at 15-30 seconds is averaged using the software embedded in the potentiostat. The concentration of free chlorine is then determined using the average current value and the pre-loaded calibration table in the instrument.

The reagent used for measuring free chlorine can also be used in a similar manner to measure bromine.

Total Chlorine Detection Reagent Composition

The total chlorine reagent composition for the total chorine electrochemical sensor according to the invention, measures the content of total chlorine in water by the amperometric analysis. The reagent composition for the total chlorine electrochemical sensor will generally contain a potassium halide salt, a buffer component and a polymeric material. Typically, deionized water is used as the solvent for the composition and the components are added so that the resulting composition has the component present in an amount disclosed below. These components are generally mixed and applied to the second surface of the working electrode to form the total chlorine working electrode.

The potassium halide salt added to the reagent composition may be potassium bromide, and potassium chloride. Generally, the potassium salt is added in an amount such that the potassium salt is present in a concentration of about of 0.05 to 2M typically about 0.25 to about 0.75 M. One specific example is a 0.5M concentration of potassium bromide.

Suitable buffers include phthalate buffers, phosphate buffers. Phosphate buffers include, for example disodium hydrogen phosphate, sodium di-hydrogen phosphate and mixtures thereof. Suitable phthalate buffers include potassium hydrogen phthalate. The buffer component is generally present in the reagent composition in the range of about 0.01 to about 0.3 M. The pH of the buffer solution should be adjusted to the range around 4-5 pH is generally adjusted using a diluted hydrochloric acid (HCl), such as 0.1 M HCl.

In addition, the reagent composition will also have a polymeric component added to assist disposition of the potassium salt and buffer to the surface of the electrode. In addition, the polymeric material in the reagent composition is used to retain reagent and buffer mixture on the electrode surface, and stabilizing the response of electrochemical detection. Possible polymers include, for example, polyvinyl alcohol, sodium alginate, or other similar polyelectrolyte polymers. Generally, sodium alginate is used for the total chlorine sensor. Typically, the polymer is added in an amount of about 0.1 to about 2.0% by weight, based on the weight of the solution.

Total chlorine is measured amperometically by applying a voltage to the working electrode and measuring the current from the working electrode. Combined chlorine is then determined by difference between the total chlorine and free chlorine contents. Potassium bromide can react with free chlorine and combined chlorine as follows:

OCl⁻+2Br⁻+2H⁺↔Br₂+Cl⁻+H₂O

Cl₂+2Br⁻↔Br₂+2Cl⁻

NH₂Cl+2Br⁻+2H⁺↔Br₂+Cl⁻+NH₄⁺

RNHCl+2Br⁻+2H⁺↔Br₂+Cl⁻+RNH₃⁺

The liberated bromine is reduced electrochemically at the electrode as shown below:

Br₂+2e⁻↔2Br⁻

Calcium Hardness Detection Reagent Composition

The calcium hardness sensor according to the invention measures the content of calcium ion in water by the amperometric analysis. The reagent used in the calcium hardness reagent composition is an electrochemical indicator for the detection of calcium ion and other complexometric indicators. The reagent composition for the hardness electrochemical sensor will generally contain an electrochemical indicator for the detection of calcium ion and other complexometric indicators, a buffer component and a polymeric material. Typically, deionized water is used as the solvent for the composition and the components are added so that the resulting composition has the component present in an amount disclosed below.

The electrochemical indicator for the detection of calcium ion and other complexometric indicators are generally present in the reagent composition in an amount in the range of about 1 to 10 mM, typically about 2-4 mM. Suitable compounds for this component include Alizarin Red, Alizarin Yellow CG, Alizarin Green, Alizarin Blue Black B, and Eriochrome Black T. Of these, Alizarin Red S (3,4-dihydroxy-9,10-dioxo-2-anthracenesulfonic acid sodium salt) is typically used as an electrochemical indicator for the detection of calcium ion.

Suitable buffers include phthalate buffers, phosphate buffers and an acetate buffer. Phosphate buffers include, for example disodium hydrogen phosphate, sodium di-hydrogen phosphate and mixtures thereof. Suitable phthalate buffers include potassium hydrogen phthalate. The buffer component is generally present in the reagent composition in the range of about 0.01 to about 0.3 M. The pH of the buffer solution should be adjusted to the range around 3-4 pH is generally adjusted using a diluted hydrochloric acid (HCl), such as 0.1M HCl.

In addition, the reagent composition will also have a polymeric component added to assist disposition of the Alizarin Red S, and buffer to the surface of the electrode. In addition, the polymeric material in the reagent composition is used to retain reagent and buffer mixture on the electrode surface, and stabilizing the response of electrochemical detection. Possible polymers include, for example, polyvinyl alcohol, polyvinylpyrrolidone, sodium alginate, or other similar polyelectrolyte polymers. Generally, polyvinyl alcohol or polyethylene oxide is used for the calcium hardness sensor. Typically, the polymer is added in an amount of about 0.05 to about 5.0% by weight, based on the weight of the solution. More preferably, the polymer is added in an amount of about 1.5 to 3% by weight, based on the weight of the solution.

Suitable buffers include phthalate buffer, phosphate buffer, and acetate buffer in a pH range of 3.0 to 4.0. Suitable polymer materials may include, but not limited to sodium alginate, polyvinyl alcohol, polyvinylpyrrolidone, polyethylene oxide or other polyelectrolytes.

In another embodiment, the calcium hardness reagent is a copper (II) ions pre-loaded into a cationic ion exchange resin in lieu of a buffer and alizarine Red S. The copper loaded/resin is combined with a polymeric material, as described above, to prepare the reagent composition.

In another embodiment, the measurement of calcium ions in water is made by the electrochemical detection of copper (II) ion that is released from cation exchange resin via ion exchange reaction. Copper salts in anhydrous or hydrated form are used as the source of copper (II) ions. Possible copper (II) salts include, but are not limited to, copper sulfate, copper chloride and copper nitrate. Copper (II)-bounded cation exchange resin is prepared by soaking the resin in appropriate copper salt solution, drying the treated resin. The exchange resin is then mixed with a polymeric binder in water, as described above, to prepare the reagent composition. The water is then evaporated with heat to deposit the resin and polymer on top of the electrode.

Suitable cation exchange resins include cation exchange resins commonly made of styrene and cross-linking agent divinyl benzene, which are post-functionalized to contain sulfonic acid groups, carboxylic acid groups, or their corresponding salts. Suitable cation exchange resins used to prepare the calcium hardness sensor include cation exchange resins sold under the trade names Amberlite®, Amberlist®, Dowex®, Duolite® that bear sulfonic acid or carboxylic acid groups, or their corresponding Na⁺ or H⁺ salt form.

Total Alkalinity Detection Reagent Composition

The total alkalinity sensor according to the invention measures the contents of carbonate and bicarbonate in water by the amperometric analysis using manganese compound as the reagent. Suitable manganese compounds include, for example, manganese (II) salts, including but not limited to manganese perchlorate, manganese acetate, manganese chloride, manganese nitrate, manganese sulfate. Typically, the reagent composition manganese (II) perchlorate as the reagent and a polymeric material. The manganese (II) perchlorate reagent is generally present in a concentration of 5 to 100 mM, typically between about 20 to 40 mM.

In addition, the reagent composition will also have a polymeric component added to assist disposition of the manganese (II) perchlorate to the surface of the electrode. In addition, the polymeric material in the reagent composition is used to retain reagent on the electrode surface, and stabilize the response of electrochemical detection. Possible polymers include, for example, polyvinyl alcohol, polyvinylpyrrolidone, sodium alginate, polyethylene oxide or other similar polyelectrolyte polymers. Generally, polyvinylpyrrolidone is used for the total alkalinity sensor. Generally, the polymer is added in an amount of about 0.5 to about 5.0% by weight, based on the volume of the solution. Typically the polymeric component will be about 1.5 to about 3% by weight of the composition.

Mn²⁺ ions complex with bicarbonate ions at a desirable pH range of 7.2-7.6 in pool water as shown below:

Mn²⁺(aq)+2HCO₃⁻↔[Mn(HCO₃)₂]

The Mn-bicarbonate complex is then oxidized electrochemically at the electrode as shown below:

[Mn(HCO₃)₂]↔Mn³⁺+2HCO₃⁻+e⁺

Cyanuric Acid Detection Reagent Composition

The cyanuric acid sensor according to the invention measures the content of cyanuric acid in water by the amperometric analysis using copper (II) ions that can come from any compound or sources such as transition metal (II) salts which examples are, sulfates, nitrates, and chlorides salts. Typically, the reagent composition contains copper (II) ions coming from a typical 1000 ppm analytical copper solution standard in nitric acid as the reagent and a polymeric material. The copper (II) ion reagent is generally present in a concentration of 5 to 100 ppm (as Cu), typically between about 5 to 20 ppm.

The reagent composition has a polymeric component added to assist binding of the copper (II) to the surface of the working electrode. In addition, the polymeric material in the reagent composition is used to stabilize the response of electrochemical detection. Possible polymers include, for example, polyethylene glycol, polyvinyl alcohol, polyvinylpyrrolidone, or other similar polyelectrolyte polymers. Generally, polyvinyl alcohol is used to prepare the cyanuric acid sensor. Generally, the polymer is added in an amount of about 0.05 to about 5.0% by weight, based on the volume of the solution. Typically the polymeric component will be about 0.05 to about 1% by weight of the composition.

Copper Ion Detection Reagent Composition

The copper ion sensor according to the invention measures the copper content in water by squarewave voltammetry using a buffer deposited on the working electrode. Typically, the buffer has pH ranging from 3 to 4, such as 3.4. Suitable buffers, for example, include phthalate, phosphate, citrate and acetate buffers with phthalate buffers being preferred.

Borate Detection Reagent Composition

The borate sensor measures the content of borates in water by the amperometric analysis using a manganese compound as the reagent. Suitable manganese compounds include, for example, manganese (II) salts, including but not limited to manganese perchlorate, manganese acetate, manganese chloride, manganese nitrate, manganese sulfate. Typically, the reagent composition manganese (II) sulfate as the reagent and a polymeric material. The manganese (II) sulfate reagent is generally present in a concentration of 5 to 100 mM, typically between about 20 to 40 mM.

In addition, the reagent composition will also have a polymeric component added to assist disposition of the manganese (II) sulfate to the surface of the electrode. In addition, the polymeric material in the reagent composition is used to retain reagent on the electrode surface, and stabilize the response of electrochemical detection. Possible polymers include, for example, polyvinyl alcohol, polyvinylpyrrolidone, sodium alginate, polyethylene oxide or other similar polyelectrolyte polymers. Generally, polyvinylpyrrolidone is used for the borate sensor. Generally, the polymer is added in an amount of about 0.01 to about 5.0% by weight, based on the volume of the solution. Typically the polymeric component will be about 0.01 to about 0.08% by weight of the composition.

Iron Ion Detection Reagent Composition

In order to detect iron, an iron reagent can be placed into the water tray (as opposed to being directly applied to one or more electrodes). Iron ions, for instance, can be detected by using an iron reagent that contains primarily lactose monohydrate. The lactose monohydrate can be present in an amount from about 60% to about 90% by weight. In addition, the reagent composition can contain sodium chloride, sodium sulfate, sodium dithionite, sodium metabisulfite, and 2,2-bipyridyl. The sodium metabisulfite can be present in the reagent composition in an amount from about 10% to about 15% by weight. The remaining ingredients can be present in an amount from about 1% to about 5% by weight.

Hydrogen Peroxide Detection Reagent Composition

In order to detect hydrogen peroxide, a hydrogen peroxide reagent composition can contain an iron compound, such as an iron (II) or iron (MI) compound, such as hexacyanoferrate (II, III). For instance, in one embodiment, the hydrogen peroxide reagent composition may contain a polymer in combination with from about 0.5% to about 5% by weight of Prussian blue. The polymer can comprise any of the polymers described above with respect to the total alkalinity reagent. The polymer, for instance, can comprise polyvinyl alcohol.

Referring back to FIG. 3, during operation of the electrochemical device 50, an analyzing device can be electrically connected to each of the electrodes. In this regard, the electrochemical device 50 can include a plurality of electrical contacts for electrically connecting to each of the electrodes. For instance, each of the working electrodes 72 can include electrical contacts 102. Reference electrode 74, on the other hand, can include electrical contacts 100. Counter electrode 76 can include electrical contacts 104. In one embodiment, the common counter electrode 76 can include just a single electrical contact.

The isolated electrochemical sensor 70 can include its own electrical contact. For instance, working electrode 90 can include an electrical contact 110, reference electrode 92 can include an electrical contact 108, and counter electrode 94 can include an electrode contact 106. In the isolated electrochemical cell 70, the counter electrode 94 may not be held at a common potential voltage. By being isolated from the remainder of the electrochemical cells, for instance, a voltage can be applied to the counter electrode 94 using the electrical contact 106.

As described above, in one embodiment, the electrodes of the different electrochemical cells can be formed by applying one or more coatings to the support 51. Referring to FIG. 4, one embodiment of an electrode and electrical contact construction is shown.

In the embodiment illustrated in FIG. 4, for instance, the reference electrodes 74 and the electrical contacts 100 can be made from a conductive metallic composition applied to the support 51. For example, in one embodiment, the reference electrodes 74 including the electrical contacts 100 are made by applying a silver compound, such as silver chloride to the support.

The working electrode 72 and the counter electrode 76, on the other hand, can be made from multiple layers of materials. For example, the electrodes 72 and 76 can include a metallic trace layer 120 that can be applied first to the support 51. The metallic trace layer, for instance, may comprise a conductive silver, such as silver ions or a silver compound. The metallic trace layer 120 is then covered by a carbonized trace layer 122. As shown, the carbonized trace layer can have a width that is wider than the width of the metallic trace layer 120. In this manner, the carbonized trace layer 122 completely covers the metallic trace layer 120. The carbonized trace layer 122 can be made from any suitable conductive carbon source. For example, the carbonized trace layer 122 can be made from carbon black, graphite particles, or the like. A metallic trace layer, such as conductive silver underneath a carbonized layer, is used, at least in part, to lower the impedance of the conductors thus reducing any voltage potential gradients that can occur over the lengths of the conductors that become problematic when higher current is required for analyzing certain reagent compounds. Lower impedance traces can improve mitigation of adjacent cell interference caused by a gradient voltage appearing on an area of the counter electrode of an adjacent cell. Conductors that exhibit zero impedance would not exhibit any voltage gradient when higher currents are being passed. The metalized substrate can cause electrodes to exhibit lower impedance and improve operation of the potentiostat.

The electrical contacts 102 and 104 for the working electrodes and the counter electrode can generally be made from any suitable conductive material that is electrically connected to the corresponding electrodes. In one embodiment, for instance, the electrical contacts 102 and 104 are formed from a conductive silver composition, such as silver ions or a silver compound.

As shown in FIG. 3, in one embodiment, the electrochemical device 50 can optionally include an insulating strip 150 that extends over portions of the electrodes in between the electrodes and the electrical contacts. The insulating strip 150 can be used to handle the electrochemical device 50 and/or prevent against damage prior to or during use. The insulating strip 150 can also prevent the electrical contacts from having direct contact with a fluid to be tested. In this manner, the electrical contacts are prevented from interfering with the electrodes during measurement. The insulating strip 150 can be made from any suitable nonconductive material. Exemplary materials include, for example, dielectric polymeric materials such as polyesters, polyvinyl chloride, and other similar compatible polymers. The insulating strip 150 can also result in more consistent electrode exposure to the fluid to be tested. The insulating strip 150 permits the electrochemical device to be inserted into the fluid to be tested with reduced or less precise mechanical tolerance since the electrochemical device can be inserted deeper into the fluid but with consistent electrode exposure which allows for the fluid to completely or nearly completely cover the exposed electrodes.

During use of the electrochemical device 50, the electrochemical device 50 can be placed in an apparatus for measuring analytes in a fluid sample. For example, in one embodiment, the electrochemical device 50 can be placed in a holding device. The holding device can be configured to hold the electrochemical device 50 and place the device 50 into a reservoir that holds a fluid sample. An analyzing device can be connected to each of the electrodes on the electrochemical device 50 and can be designed to apply voltages to certain of the electrodes and measure electrical currents within each electrochemical cell. Based on the measured electrical current, the device can be configured to indicate an analyte concentration within the fluid sample. Of particular advantage, multiple analytes can be measured simultaneously without electrical interference.

FIG. 5 depicts a diagram of a conventional potentiostat circuit including multiple conventional potentiostats which may be used for the purpose of attempting to measure analytes in an uncompartmented or galvanically connected fluid sample or electrochemical cell. Potentiostat circuit 500 includes two conventional potentiostats, first conventional potentiostat 501 and second conventional potentiostat 502. First conventional potentiostat 501 includes a counter electrode 505, working electrode 507 and reference electrode 509. Second conventional potentiostat 502 includes a counter electrode 506, working electrode 508 and reference electrode 510. Counter electrodes 505 and 506 are isolated in that they are not physically connected or otherwise in physical contact with one another. Counter electrodes 505 and 506, working electrodes 507 and 508 and reference electrodes 509 and 510, can be submerged in an uncompartmented or galvanically connected fluid sample or electrochemical cell for the purpose of measuring analytes in the fluid sample.

For conventional potentiostat 501, an input supply 511 is used to control the potential or voltage difference between working electrode 507 and reference electrode 509. The voltage difference between working electrode 507 and reference electrode 509 can be a positive voltage (V_{RE}>V_{WE}), a negative voltage (V_{RE}<V_{WE}) or an alternating current voltage either with or without a positive or negative DC voltage bias. Conventional potentiostat 501 attempts to control the voltage difference between working electrode 507 and reference electrode 509 to a first user supplied set point 541 (V_{ISET}). The first user supplied voltage set point 541 is determined by the user of conventional potentiostat 501 and is based, at least in part on, the analytes that are being measured in the electrochemical cell and the contents of the electrochemical cell. Conventional potentiostat 501 controls the voltage difference between working electrode 507 and reference electrode 509 by injecting current into the uncompartmented or galvanically connected fluid sample or electrochemical cell through counter electrode 505. Proper function of potentiostat 501 would result in a current flowing into the uncompartmented or galvanically connected fluid sample or electrochemical cell via the working electrode 507 and leaving the uncompartmented or galvanically connected fluid sample or electrochemical cell via the counter electrode 505. Consequently, proper function of potentiostat 501 would result in working electrode current 523 (I₁ₐ) being equivalent to counter electrode current 525 (I_{1b}). Conventional potentiostat 501 includes a measurement resistor 531 (R₁ₘ), which is used to obtain a measured voltage 551 (V₁ₘ). Measured voltage 551 and the resistance of measurement resistor 531 are used to measure or determine measured current 561 (V₁ₘ=I₁ₘ×R₁ₘ) which is the amount of current flowing between working electrode 507 and counter electrode 505. When conventional potentiostat 501 is operating properly measured current 561 is equivalent to working electrode current 523 (I₁ₘ=I₁ₐ). Measured current 561(I₁ₘ) is then utilized to generate an output measurement signal proportional to the measured current 561. The output measurement signal indicates a change in the resistance between working electrode 507 and reference electrode 509 and therefore, indicates an electrochemical property of a solution in contact with counter electrode 505, working electrode 507 and reference electrode 509.

For conventional potentiostat 502, an input supply 512 is used to control the potential or voltage difference between working electrode 508 and reference electrode 510. The voltage difference between working electrode 508 and reference electrode 510 can be a positive voltage (V_{RE}>V_{WE}), a negative voltage (V_{RE}<V_{WE}) or an alternating current voltage either with or without a positive or negative DC voltage bias. Conventional potentiostat 502 attempts to control the voltage difference between working electrode 508 and reference electrode 510 to a second user supplied set point 542 (V_{2SET}). The second user supplied voltage set point 542 is determined by the user of conventional potentiostat 502 and is based, at least in part on, the analytes that are being measured in the electrochemical cell and the contents of the electrochemical cell. Conventional potentiostat 502 controls the voltage difference between working electrode 508 and reference electrode 510 by injecting current into the uncompartmented or galvanically connected fluid sample or electrochemical cell through counter electrode 506. Proper function of potentiostat 502 would result in a current flowing into the uncompartmented or galvanically connected fluid sample or electrochemical cell via the working electrode 508 and leaving the uncompartmented or galvanically connected fluid sample or electrochemical cell via the counter electrode 506. Consequently, proper function of potentiostat 502 would result in working electrode current 522 (I₂ₐ) being equivalent to counter electrode current 524(I_{2b}). Conventional potentiostat 502 includes a measurement resistor 532 (R₂ₘ), which is used to obtain a measured voltage 552 (V₂ₘ). Measured voltage 552 and the resistance of measurement resistor 532 are used to measure or determine measured current 562 (V₂ₘ=I₂ₘ×R₂ₘ) which is the amount of current flowing between working electrode 508 and counter electrode 506. When conventional potentiostat 502 is operating properly measured current 562 is equivalent to working electrode current 522 (I₂ₘ=I₂ₐ). Measured current 562 (I₂ₘ) is then utilized to generate an output measurement signal proportional to the measured current 562. The output measurement signal indicates a change in the resistance between working electrode 508 and reference electrode 510 and therefore, indicates an electrochemical property of a solution in contact with counter electrode 506, working electrode 508 and reference electrode 510. The conventional potentiostat circuit topology can include an output device to receive the measurement output signal.

When conventional potentiostat 501 and conventional potentiostat 502 are operated simultaneously, the voltage applied to counter electrode 505 may be different as compared to the voltage applied to counter electrode 506. When different voltages are simultaneously applied to counter electrode 505 and counter electrode 506, each counter electrode injects different amounts of current into the same uncompartmented or galvanically connected fluid sample or electrochemical cell. This condition can cause a current imbalance between conventional potentiostat 501 and conventional potentiostat 502. This condition can also cause leakage current 520 (I_{LEAK}) to flow between conventional potentiostat 501 and conventional potentiostat 502. For example, leakage current 520 (I_{LEAK}) can include a portion of the working electrode current 522 (I₂ₐ) from conventional potentiostat 502 and leakage current 520 may travel through the uncompartmented or galvanically connected fluid sample or electrochemical cell to counter electrode 505 of conventional potentiostat 501. As such, rather than only current from working electrode 507 leaving the electrochemical cell via counter electrode 505, the current leaving the electrochemical cell via counter electrode 505 will include current from working electrode 507 and leakage current 520 (I_{LEAK}+I₂ₐ). Consequently, the current flowing through measurement resistor 551 (I₂ₘ) of conventional potentiostat 501 would include working electrode current 523 and leakage current 520 (I_{LEAK}+I₂ₐ). As a result, the current flowing through the uncompartmented or galvanically connected fluid sample or electrochemical cell between working electrode 508 and counter electrode 506 would be different than the current value determined or calculated using the measured voltage 551(V₂ₘ=R₂ₘ (I_{LEAK}+I₂ₐ)), which is obtained at measurement resistor 531. Consequently, controllers for conventional potentiostat 501 and conventional potentiostat 502 will be unable to properly regulate or control the voltage difference between their respective working electrodes (507 and 508) and reference electrodes (509 and 510) and fail to produce accurate and meaningful results.

While leakage current 520 has been described as flowing from conventional potentiostat 502 to conventional potentiostat 501, this example is provided by way of explanation and not limitation. Those skilled in the art will appreciate that in certain operating conditions, leakage current 520 could also flow from conventional potentiostat 501 to conventional potentiostat 502 or flow between any number of conventional potentiostats which may be submerged or used in the same uncompartmented or galvanically connected fluid sample or electrochemical cell.

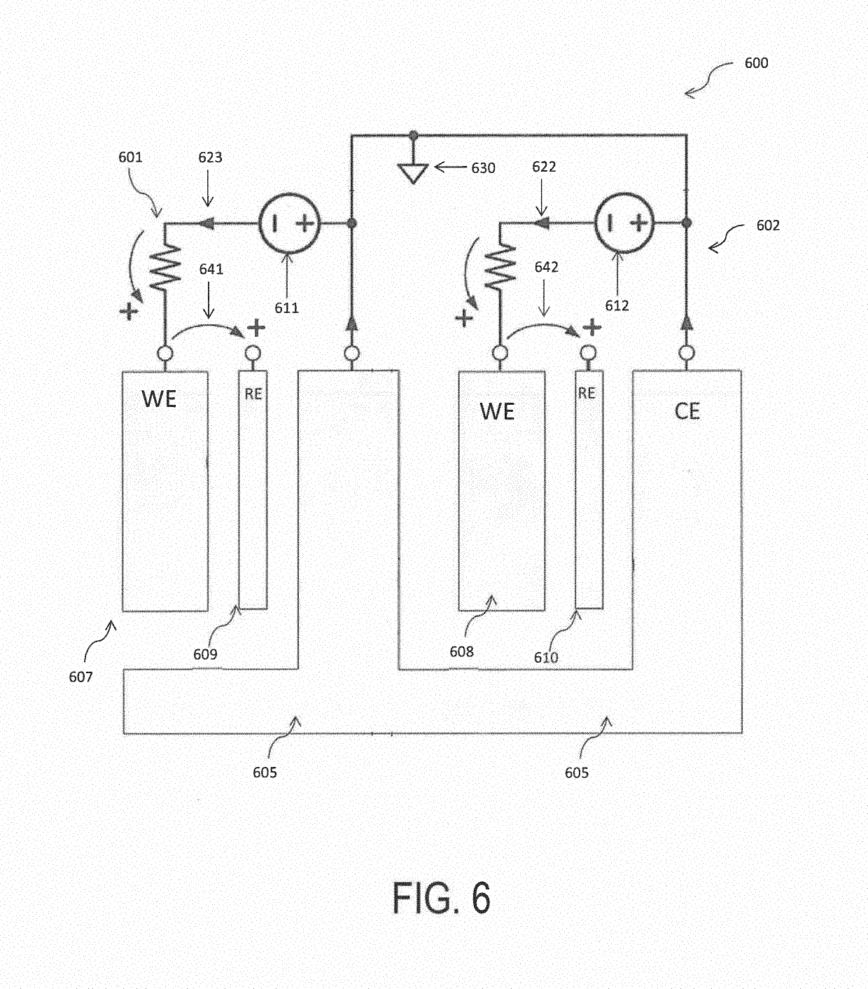

FIG. 6 depicts a diagram of an example non-conventional potentiostat circuit according to example embodiments of the present disclosure. Non-conventional potentiostat circuit 600 includes two non-conventional potentiostats, such as first non-conventional potentiostat 601 and second non-conventional potentiostat 602. Non-conventional potentiostat 601 includes a working electrode 607, a reference electrode 609 and a common counter electrode 605, which is shared with, physically connected to or otherwise in direct electrical contact with the counter electrode of non-conventional potentiostat 602. Counter electrode 605 is depicted in FIG. 6 with a unitary construction; however, those skilled in the art will appreciate that other configurations may be utilized for common counter electrode 605. For example, common counter electrode 605 can include multiple counter electrodes that are physically connected or otherwise in direct electrical contact with one another. Non-conventional potentiostat 602 includes a working electrode 608, a reference electrode 610 and the common counter electrode 605. Non-conventional potentiostat 601 and 602 share or are each physically connected or otherwise in direct electrical contact with common counter electrode 605.

The common counter electrode 605, working electrodes 607 and 608 and reference electrodes 609 and 610, can be submerged in an uncompartmented or galvanically connected fluid sample for the purpose of measuring analytes in the fluid sample. For each non-conventional potentiostat 601 and 602, an input supply 611, 612 is used to control a voltage difference (641 and 642) between the reference electrodes (609 and 610) and the working electrodes (607 and 608). The common counter electrode 605 is held at a common potential voltage, such as at circuit ground 630 (+0V DC), and is configured to prevent against electrical interference, leakage current, between non-conventional potentiostat 601 and 602 when measuring analytes in a fluid sample.

Unlike conventional potentiostats, such as potentiostats 501 and 502 depicted in FIG. 5, which control the voltage difference between a working electrode, such as working electrodes 507 or 508, and a reference electrode, such as reference electrodes 509 or 510, by injecting current into the uncompartmented or galvanically connected fluid sample or electrochemical cell through a counter electrode, such as counter electrodes 505 or 505, non-conventional potentiostats, such as potentiostats 601 and 602, control the voltage difference between a working electrode and a reference electrode via the working electrode.

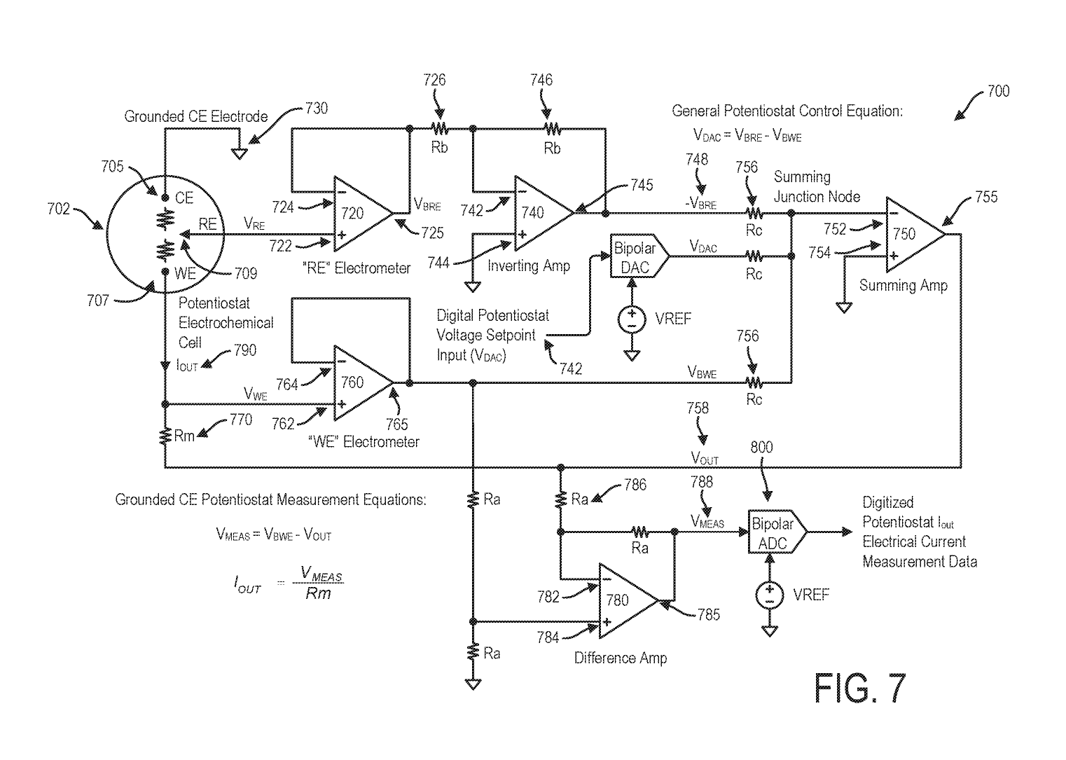

For non-conventional potentiostat 601, an input supply 611 is used to control the potential or voltage difference between working electrode 607 and reference electrode 609. The voltage difference 641 between working electrode 607 and reference electrode 609 can be a positive voltage (V_{RE}>V_{WE}), a negative voltage (V_{RE}<V_{WE}) or an alternating current voltage either with or without a positive or negative DC voltage bias. Non-conventional potentiostat 601 controls the voltage difference 641 between working electrode 607 and reference electrode 609 such that the voltage difference is equivalent or nearly equivalent to a first user supplied set point 641 (V_{1SET}). The first user supplied voltage set point 641 is determined by the user of non-conventional potentiostat 601 and is based, at least in part on, the analytes that are being measured in the electrochemical cell and the contents of the electrochemical cell. Non-conventional potentiostat 601 controls the voltage difference between working electrode 607 and reference electrode 609 by injecting current into the uncompartmented or galvanically connected fluid sample or electrochemical cell through working electrode 607. In this configuration, and as a more fully described in FIG. 7, a first high impedance circuit component is connected to working electrode 607 and a second high impedance circuit component is connected to reference electrode 609. Non-conventional potentiostat 601 controls the voltage difference between working electrode 607 and reference electrode 609 by permitting dynamic changes in voltage, relative to ground, of both the working electrode 607 and reference electrode 609. As used herein, the term high impedance can include a known circuit component that possesses high impedance, such as an op-amp or electrometer. In some embodiments, a high impedance component is a circuit component that possesses impedance that can limit the amount of current flowing to the reference electrode (609 and 610) from the electrochemical cell. For example, a high impedance input will operate such that less than 1% of the bias current flowing in the electrochemical cell flows to the reference electrode (609 and 610). Additionally, in some embodiments, a high impedance input will operate such that less than 10% of the bias current flowing in the electrochemical cell flows to the reference electrode (609 and 610). In some embodiments, if the bias current in the electrochemical cell is 1 milliamp, the impedance of the high impedance component will limit the current flowing to the reference electrode to 15 picoamps or less.

When the common counter electrode 605 is held at a common potential voltage, proper function of the first non-conventional potentiostat 601 would result in voltage being applied by the input supply 611 to working electrode 607, and permits the maintenance of a constant cell reference voltage 641 between the working electrode 607 and the reference electrode 609, by permitting dynamic changes in voltage, relative to ground, of both the working electrode 607 and reference electrode 609. Similarly, when the common counter electrode 605 is held at a common potential voltage, proper function of the second non-conventional potentiostat 602 would result in voltage being applied by the input supply 612 to working electrode 608, and permits the maintenance of a constant cell reference voltage 642 between the working electrode 608 and the reference electrode 610 by permitting dynamic changes in voltage, relative to ground, of both the working electrode 608 and reference electrode 610.

Proper function of non-conventional potentiostats 601 and 602 result in working electrode current 622 (I₁ₐ) and working electrode current 623 (I₂ₐ) to be injected into and traveling through the uncompartmented or galvanically connected fluid sample or electrochemical cell to the common counter electrode 605 and to ground 630. In this respect, non-conventional potentiostats 601 and 602 prevent leakage current from flowing between electrochemical cells.

FIG. 7 depicts a diagram of an electrical schematic of a non-conventional potentiostat circuit according to example embodiments of the present disclosure. Potentiostat circuit 700 includes a three terminal electrochemical cell 702. Potentiostat circuit 700 includes a common counter electrode 705, working electrode 707 and reference electrode 709, which can be part of an electrochemical sensor such as those depicted in FIGS. 1 through 4, and said electrodes can be submerged in an uncompartmented or galvanically connected fluid sample for the purpose of measuring analytes in the fluid sample.

Common counter electrode 705 is held at a common potential voltage, such as at circuit ground 730 (+0V DC). A user supplied set point 742 (V_{DAC}), which is determined by the user of potentiostat 700 and is based, at least in part on, the analytes that are being measured in the electrochemical cell and the contents of the electrochemical cell, is input into the potentiostat circuit 700, by a digital to analog converter or another known device of similar function. Potentiostat circuit 700 controls the voltage difference between working electrode 707 and reference electrode 709 to be equal or nearly equivalent to the user the supplied set point 742 (V_{DAC}).

Reference electrode 709 is connected to a first input terminal 722 of a first high impedance device, such as electrometer 720. Electrometer is used to measure the voltage present (V_{RE}) at reference electrode 709. Voltage (V_{RE}) of reference electrode 709 is received by electrometer 720 and electrometer 720 produces and output voltage (V_{BRE}). The output voltage (V_{BRE}) of electrometer 720 is connected to a second input terminal 724 of electrometer 720 such that the output voltage (V_{BRE}) of electrometer 720 is received by the second input terminal 724. Electrometer 720 can detect an imbalance between the signals received by the first input terminal 722 and the second input terminal 724. Electrometer 720 can function as a voltage follower in that after detecting an imbalance between the signals received by the first input terminal 722 and the second input terminal 724, it can maintain a null difference between them by adjusting the output voltage until such time as V_{RE} equals V_{BRE} or V_{RE} is nearly V_{BRE}.

Output terminal 725 of electrometer 720 is connected in series to one or more resistors 726, and the first input terminal 742 of an inverting amplifier 740. Second input terminal 744 of inverting amplifier 740 is connected to ground. Output terminal 745 of inverting amplifier 740 is connected in series to one or more feedback resistors 746 and to first input terminal 742, to provide feedback to inverting amplifier 740 and produce closed loop operation. Resistor 726 and feedback resistor 746 are of equal or near equal value such that the gain of the inverting amplifier 740 is negative one (−1) and the inverting amplifier 740 produces an output 748 (−V_{BRE}) which is the complementary form of V_{BRE}.

Working electrode 707 is connected to a first input terminal 762 of a second high impedance device, such as electrometer 760. Electrometer is used to measure the voltage present (V_{WE}) at working electrode 707. Voltage (V_{WE}) of working electrode 709 is received by electrometer 760 and electrometer 760 produces and output voltage (V_{BWE}). The output voltage (V_{BWE}) of electrometer 760 is connected to a second input terminal 764 of electrometer 760 such that the output voltage (V_{BWE}) of electrometer 760 is received by the second input terminal 764. Electrometer 760 can detect an imbalance between the signals received by the first input terminal 762 and the second input terminal 764. Electrometer 760 can function as a voltage follower in that after detecting an imbalance between the signals received by the first input terminal 762 and the second input terminal 764, it can maintain a null difference between them by adjusting the output voltage until such time as V_{WE} equals V_{BWE} or V_{WE} is nearly V_{BWE}.

Output terminal 765 of electrometer 760 is connected in series to one or more resistors 756 and to the first input terminal 752 of a non-inverting summing amplifier 750. Output terminal 745 of inverting amplifier 740 is connected in series to one or more resistors 756, and the first input terminal 752 of a non-inverting summing amplifier 750. Second input terminal 754 of summing amplifier 750 is connected to ground. Output 758 (V_{OUT}) of summing amplifier 750 is the sum of V_{BWE}, V_{DAC} and −V_{BRE}. Output 758 (V_{OUT}) is a control voltage that is created to assure that V_{DAC}=V_{BWE}−V_{BRE}.

Output terminal 755 of summing amplifier 750 is connected in series to one or more resistors 786, and the first input terminal 782 of a difference amplifier 780. Output terminal 765 of electrometer 760 is connected in series to one or more resistors 786 and to the second input terminal 782 of a difference amplifier 780. Output voltage 788 (V_{MEAS}) of difference amplifier 780 is equivalent to the difference of V_{BWE} and V_{OUT} (V_{MEAS}=V_{BWE}−V_{OUT}).

Working electrode 707 is connected in series with a measurement resistor 770 (Rₘ). Output voltage 788 (V_{MEAS}) of difference amplifier 780 is used with a measurement resistor 770 (Rₘ) to determine measured current 790 (I_{OUT}), which is the current flow between working electrode 707 and counter electrode 705 within electrochemical cell 702 (I_{OUT}=V_{MEAS}/Rₘ). Measured current 790 (I_{OUT}), is then utilized to generate an output measurement signal proportional to the measured current 790. The output measurement signal indicates a change in the measured current 790 (I_{OUT}), and therefore, indicates an electrochemical property of a solution in contact with counter electrode 705, working electrode 707 and reference electrode 709. Potentiostat circuit 700 includes an output device, bipolar analog to digital converter 800, to receive the measurement output signal and process the same for use with additional analog or digital devices.

A single potentiostat circuit 700 is depicted in FIG. 7. However, it will be appreciated by those skilled in the art that multiple potentiostat circuits, which are each identical to potentiostat circuit 700, may be used to simultaneously measure analytes in the same uncompartmented or galvanically connected fluid sample or electrochemical cell when the non-conventional potentiostats share a common counter electrode 705 or the counter electrodes from each of the multiple potentiostats are physically connected or otherwise in direct electrical contact with one another.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A potentiostat circuit comprising:
an electrochemical cell;
a reference electrode in electrical communication with a first high impedance component;
a working electrode in electrical communication with a second high impedance component; and
a counter electrode in electrical communication with a circuit ground.

2. The potentiostat circuit as defined in claim 1, wherein the first high impedance component is a first electrometer comprising:
a first operational amplifier which is configured to receive a reference electrode voltage at a first input terminal and generate a first output voltage based on the reference electrode voltage at a first output terminal.

3. The potentiostat circuit as defined in claim 2, wherein the second high impedance component is a second electrometer comprising:
a second operational amplifier which is configured to receive a working electrode voltage at a first input terminal and generate a second output voltage based on the working electrode voltage at a second output terminal.

4. The potentiostat circuit as defined in claim 3, the potentiostat circuit further comprising:
a third operational amplifier which includes a positive input terminal that is in electrical communication with the circuit ground and a negative input terminal that is in electrical communication with the first output terminal, and the third operational amplifier is configured to receive the first output voltage at the negative input terminal and generate a third output voltage that is based on the first output voltage.

5. The potentiostat circuit as defined in claim 4, the potentiostat circuit further comprising:
a fourth operational amplifier which includes a positive input terminal that is in electrical communication with a circuit ground and a negative input terminal that is in electrical communication with the third output terminal, the second output terminal and a digital to analog converter, and the fourth operational amplifier is configured to generate a fourth output voltage that is the sum of the voltages received at the positive input terminal.

6. The potentiostat circuit as defined in claim 5, the potentiostat circuit further comprising:
a measurement resistor in electrical communication with the working electrode; and
a fifth operational amplifier which includes a positive input terminal that is in electrical communication with the second output terminal and a negative input terminal that is in electrical communication with the fourth output terminal and the measurement resistor, and wherein the fifth operational amplifier is configured to generate a fifth output voltage indicative of an electrochemical property of a solution within the electrochemical cell.

7. The potentiostat circuit as defined in claim 6, wherein the working electrode is associated with a reagent composition for detecting an analyte in a fluid contacted with the working electrode.

8. The potentiostat circuit as defined in claim 7, wherein the counter electrode has a U-like shape that defines an electrode receiving area.

9. The potentiostat circuit as defined in claim 8, wherein the common counter electrode comprises an array of interconnected U-shaped sections, each U-shaped section serving as a counter electrode for a corresponding electrochemical cell, each U-shaped section defining a corresponding electrode receiving area.

10. The potentiostat circuit as defined in claim 9, wherein one or more of the working electrode includes a reagent composition that is an indicator for pH of a fluid contacting the working electrode.

11. The potentiostat circuit as defined in claim 9, wherein the reagent composition is formulated to detect an analyte found in blood.

12. The potentiostat circuit as defined in claim 9, wherein the reagent composition is formulated to detect an analyte comprising glucose.

13. An apparatus for measuring analytes in a fluid comprising;
a reservoir for holding a fluid;
an electrochemical sensor including a support having a first side and a second and opposite side;
at least one electrochemical cell disposed on the first side of the support, the at least one electrochemical cell including a reference electrode having an end that is contiguous with a first side and a second side, a working electrode spaced from the reference electrode that also has an end that is contiguous with a first side and a second side, and a counter electrode, the counter electrode having a shape that defines an electrode receiving area, the electrode receiving area surrounding the first side, the second side, and the end of the reference electrode and the working electrode;
a first high impedance component in electrical communication with the reference electrode;
a second high impedance component in electrical communication with the working electrode;
a circuit ground in electrical communication with the counter electrode; and
an analyzing device that electrically connects to each of the reference electrode, working electrode and counter electrode, the analyzing device being configured to simultaneously measure different analytes loaded into the fluid reservoir.
